(19) United States
(12) Patent Application Publication
(10) Pub. No.: US 2025/0195311 A1
(43) Pub. Date: Jun. 19, 2025

(54) THERAPEUTIC APPARATUS WITH FORCED COUPLING BETWEEN THE ACTUATOR SUPPORT ARM AND THE MONITOR SUPPORT ARM

(71) Applicant: Medica Medizintechnik GmbH, Hochdorf (DE)

(72) Inventors: Otto HOEBEL, Hochdorf (DE); Jakob OBLAK, Novo Mesto (SI)

(73) Assignee: Medica Medizintechnik GmbH, Hochdorf (DE)

(21) Appl. No.: 19/069,023

(22) Filed: Mar. 3, 2025

Related U.S. Application Data
(63) Continuation of application No. PCT/EP2022/074273, filed on Sep. 1, 2022.

(51) Int. Cl. A61H 1/02

(52) U.S. Cl. CPC A61H 1/0237

(57) ABSTRACT

A therapeutic apparatus comprising a frame, an actuator support arm and a monitor support arm. The actuator support arm and the monitor support arm being force-coupled such that when the actuator support arm is swiveled between a leg training position and an arm training position, the monitor support arm is also adjusted via coupling elements.

This nonprovisional application is a continuation of International Application No. PCT/EP2022/074273, which was filed on Sep. 1, 2022, and which is herein incorporated by reference.

### BACKGROUND OF THE INVENTION

### Field of the Invention

The invention relates to a therapeutic apparatus with a frame, an actuator support arm, and a monitor support arm, wherein there is a forced coupling between the actuator support arm and the monitor support arm such that when the actuator support arm is swiveled between a leg training position and an arm training position, the monitor support arm is likewise adjusted via coupling elements.

### Description of the Background Art

For rehabilitation purposes, therapeutic apparatuses are used that can be employed, in particular by wheelchair users, for appropriate arm and leg training. There are therapeutic apparatuses for this purpose in which two therapeutic drive units, one each for arm training and leg training, are simultaneously integrated. However, the therapeutic drive unit is the most expensive and complex part of a therapeutic apparatus. Moreover, when one of the units is being used, the respective other unit is in the way and appropriate execution of the exercise is hampered significantly. For this reason, there are therapeutic apparatuses that are equipped with only one adjustable drive unit, making it necessary for the caregiving staff to adjust the position for every switch between patients.

In DE 10 2007 012 244 A1, which is incorporated herein by reference, a height-adjustable training apparatus is described that is intended, in particular, for training the arms and legs of low-mobility individuals. It has a vertical support arm and a rotatable movement device.

### SUMMARY OF THE INVENTION

It is therefore an object of the present invention to improve a therapeutic apparatus such that operation of the apparatus is made easier and the training experience is made more pleasant.

The therapeutic apparatus according to an example of the invention in this case includes a forced coupling between the actuator support arm and the monitor support arm such that when the actuator support arm is swiveled between a leg training position and an arm training position, the monitor support arm is likewise adjusted via coupling elements. Switching between patients for whom different extremities are to be given training or therapy is thus made significantly easier for staff and also takes less time, since only the actuator support arm must be adjusted, and in this process the monitor associated with the monitor support arm assumes, under positive control, the position that is more favorable for good viewing in the different training positions. In this case, the coupling elements are formed by struts that are articulated to one another so as to achieve the forced coupling in a simple manner with a mechanically uncomplicated construction by a swiveling of the actuator support arm.

The actuator support arm can be connected to the monitor support arm by a first strut and a first articulated joint. The monitor support arm is connected to the frame by a second strut and a second articulated joint. In addition, the second strut can be formed in multiple parts with a multiplicity of strut sections, of which adjacent strut sections are each coupled to one another by a connecting joint in order to further optimize the positioning of the monitor arm. For the same purpose, one of the strut sections can be telescoping in design, in particular the strut section that is connected to the frame, since in this way the adjustment of the monitor support arm can be varied, and thus customized, by customizing the extension of the strut section.

The monitor support arm can be connected by a slotted link to a fourth articulated joint with a monitor. As a result, the monitor can be tilted relative to the monitor support arm and slid along the slotted link in the longitudinal direction of the monitor support arm.

In order to facilitate adjustment of the actuator support arm, a motor and/or a spring can be provided for adjustment of the actuator support arm. The spring can be designed as a gas spring in this case.

In order to allow operation of the training unit by a user, extremity connection units can be provided that are equipped in each case with two hand grips or foot holders or pedals.

The features and combinations of features mentioned above in the description, as well as the features and combinations of features mentioned below in the figure description and/or shown only in the figures can be used not only in the combination specified in each case, but also in other combinations or alone, without departing from the scope of the invention. Consequently, embodiments that are not explicitly shown in the figures or explained but that emerge from and can be produced from separate combinations of features from the explained embodiments should also be considered as encompassed by and disclosed by the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of the therapeutic apparatus in a leg training position,

FIG. 2 shows a side view from the right of the therapeutic apparatus in the leg training position,

FIG. 3 shows a perspective view of the therapeutic apparatus in the arm training position,

FIG. 4 shows a side view from the left of the therapeutic apparatus in the arm training position, and

FIG. 5 shows a superimposed side view of the therapeutic apparatus in an arm training position and in a leg training position in a representation corresponding to FIG. 4.

### DETAILED DESCRIPTION

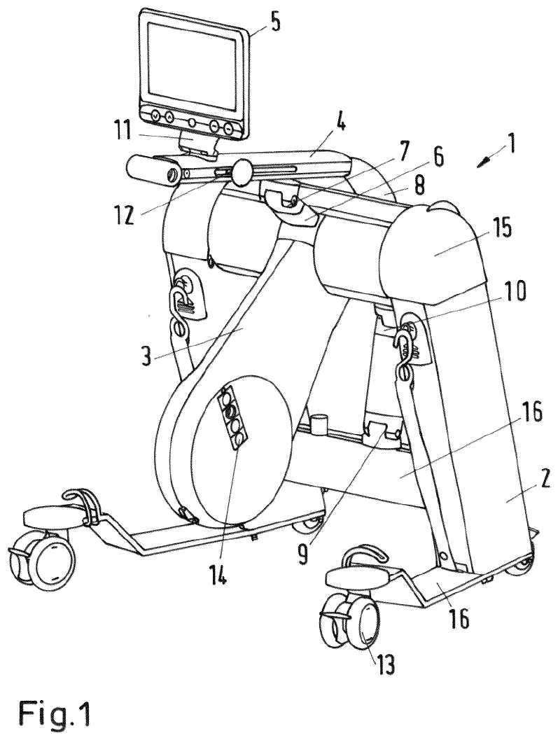

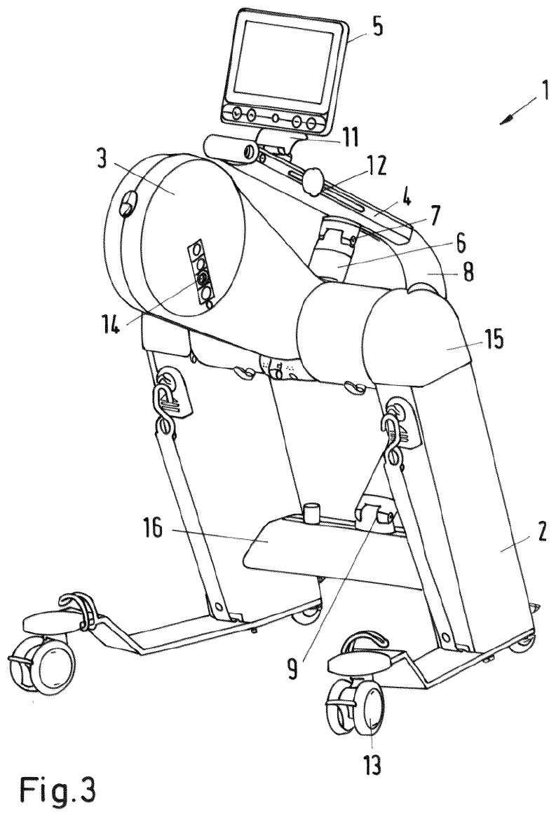

FIGS. 1 and 3 show a perspective view of the therapeutic apparatus 1 in a leg training position and in an arm training position. The therapeutic apparatus 1 is equipped with a frame 2 that has two legs and each has a base 16, wherein each base 16 stands on wheels 13 that are lockable in order to be able to fix the therapeutic apparatus 1 in place after transport. At their upper end, the legs of the frame 2 are connected by a first connecting piece 15 to form a frame. The first connecting piece 15 supports the actuator support arm 3. So that the monitor arm 4 is also adjusted when the actuator support arm 3 is adjusted, the two are force-coupled by a first strut 6 and a first articulated joint 7. Such a connection corresponds to a coupling element. The monitor support arm 4 is attached to the frame 2 by a second strut 8 and a second articulated joint 9 on a lower-lying, second connecting piece 16. The lower-lying, second connecting piece 16 likewise connects the two legs of the frame.

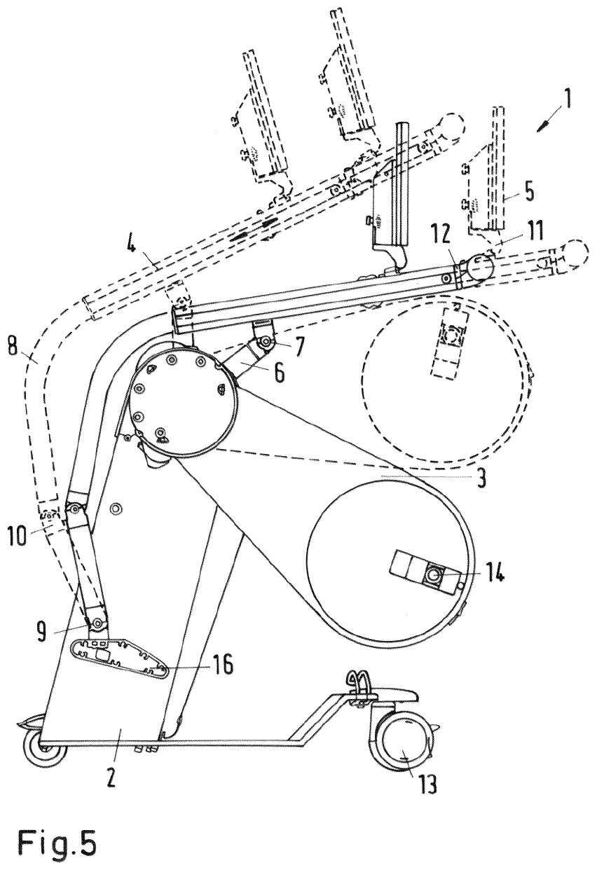

The second strut 8 can be formed in multiple parts from a multiplicity of strut sections. FIG. 5 shows a side view of the therapeutic apparatus 1, from which this subdivision is evident. In the present example, the second strut 8 is subdivided into two strut sections, which are connected to one another by a third articulated joint 10. This division optimizes the customization of the freedom of motion of the monitor arm 4. At least one of the strut sections can be telescoping in design; preferably, the strut section that is connected to the frame 2 is chosen for this purpose. The freedom of motion of the monitor support arm 4 is further optimized as a result.

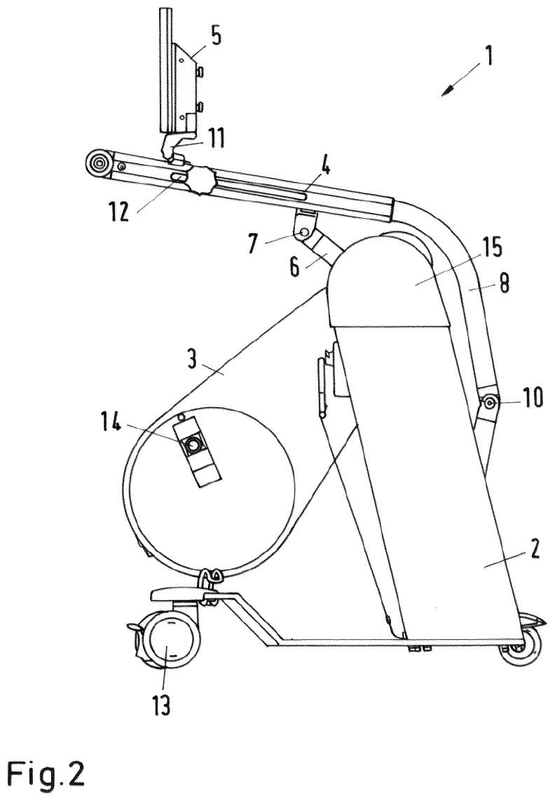

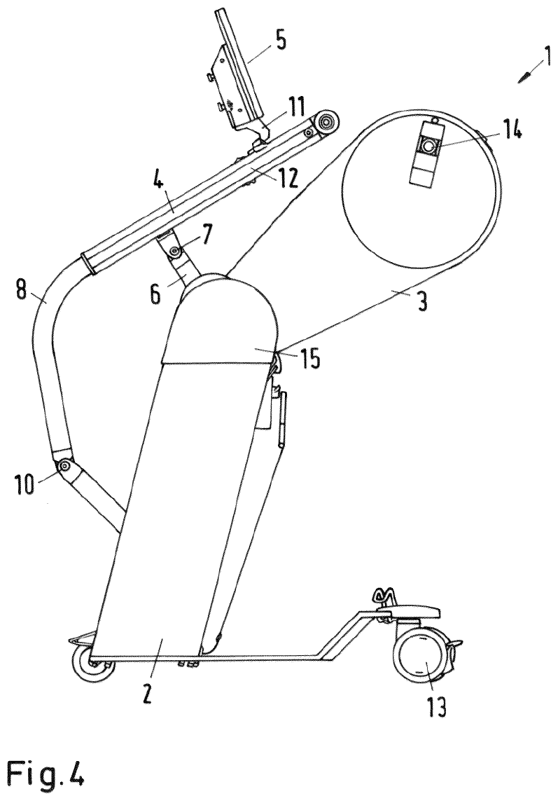

Visible in each of FIGS. 1 to 5 is a slotted link 12 that is arranged in the monitor support arm 4 and serves to adjust the position of the monitor 5. The monitor support arm 4 is connected to the monitor 5 by a fourth articulated joint 11 that can slide in the slotted link 12. In this way, it is not only possible to move the monitor 5 along the monitor support arm 4, but a tilting of the monitor 5 relative to the monitor arm 4 is also possible.

For adjustment of the actuator support arm 3, a motor is provided that is assisted by a spring, in particular a gas spring in this invention. By means of the motor, the therapeutic apparatus 1 can be brought into the desired training position without the exertion of much muscular force by the caregiving staff working with the patient.

FIGS. 1 to 5 each show receptacles 14 for extremity connection units 15 on the actuator support arm 3, by which means two hand grips or foot holders or pedals in each case can be connected to the therapeutic apparatus 1. Performance of the exercise by the person undergoing training is made possible by this means.

Possible positions of the monitor 5 are shown shaded in FIG. 5. In this example, the monitor arm 4 supports only one monitor 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A therapeutic apparatus comprising:
a frame;
an actuator support arm;
a monitor support arm; and
a forced coupling arranged between the actuator support arm and the monitor support arm such that when the actuator support arm is swiveled between a leg training position and an arm training position, the monitor support arm is likewise adjusted via coupling elements.

2. The therapeutic apparatus according to claim 1, wherein the coupling elements are formed by struts that are articulated to one another.

3. The therapeutic apparatus according to claim 2, wherein the actuator support arm is connected to the monitor support arm by a first strut and a first articulated joint.

4. The therapeutic apparatus according to claim 2, wherein the monitor support arm is connected to the frame by a second strut and a second articulated joint.

5. The therapeutic apparatus according to claim 4, wherein the second strut is formed in multiple parts with at least two strut sections, of which adjacent strut sections are each coupled to one another by a connecting joint.

6. The therapeutic apparatus according to claim 5, wherein at least one of the strut sections is telescoping in design.

7. The therapeutic apparatus according to claim 6, wherein the strut section that is connected to the frame is telescopic.

8. The therapeutic apparatus according to claim 1, wherein the monitor support arm has a slotted link for adjusting the monitor.

9. The therapeutic apparatus according to claim 8, wherein the monitor support arm is connected by the slotted link to a fourth articulated joint.

10. The therapeutic apparatus according to claim 1, further comprising a motor for adjustment of the actuator support arm.

11. The therapeutic apparatus according to claim 1, further comprising a spring for assisting the adjustment of the actuator support arm.

12. The therapeutic apparatus according to claim 1, wherein two hand grips or foot holders or pedals are adapted to be connected to the actuator support arm via extremity connection units.
